(19) United States
(12) Patent Application Publication
(10) Pub. No.: US 2026/0243722 A1
(43) Pub. Date: Aug. 20, 2026

(54) A NANOGAP ELECTRODE DEVICE, A METHOD OF MAKING A NANOGAP ELECTRODE DEVICE, AND A SENSOR FOR DETECTING A TARGET ANALYTE

(71) Applicant: Agency for Science, Technology and Research, Singapore (SG)

(72) Inventors: Musafargani SIKKANDHAR, Singapore (SG); Ming-Yuan CHENG, Singapore (SG); Yu CHEN, Singapore (SG)

(21) Appl. No.: 19/159,875

(22) PCT Filed: Mar. 1, 2024
(86) PCT No.: PCT/SG2024/050118

§ 371 Date: Aug. 26, 2025

(30) Foreign Application Priority Data
Mar. 2, 2023 (SG) 10202300557R

(51) Int. Cl. G01N 27/22; G01N 27/327

(52) U.S. Cl. CPC G01N 27/226; G01N 27/221; G01N 27/327

(57) ABSTRACT

There is provided a nanogap electrode device, a method of making a nanogap electrode device, and a sensor for detecting a target analyte, the nanogap electrode device comprising, a first electrode and a second electrode spaced apart from each other, said first and second electrodes defining a first region and a second region; wherein the first region comprises a first gap between the first electrode and the second electrode, said first gap having a first gap length and a first gap width; wherein the second region comprises a second gap between the first electrode and the second electrode, said second gap having a second gap length and a second gap width; and wherein the second gap length and second gap width are greater than the first gap width.

### TECHNICAL FIELD

The present disclosure relates broadly to a nanogap electrode device, a method of making a nanogap electrode device, and a sensor for detecting a target analyte.

### BACKGROUND

Nano biosensors are progressing as an important technology for improving the performance of a device whilst minimizing cost, size of the device and production time. In particular, nanogap capacitive biosensors are emerging as a breakthrough technology for early detection of biomarkers of fatal diseases. Nanogap capacitive biosensors represent a powerful and promising tool for detecting interactions of biomolecules due to the ease of measurement, low-cost equipment and compatibility with multiplex formats.

However, capacitive biosensors with electrode interfaces possess a shortcoming of electronic thermal noise arising from the electric double layer (EDL). Electronic thermal noise masks critical information of the biomolecules of interest for detection. One approach to overcome this drawback is by reducing the gap/separation between the capacitor electrodes to less than the EDL thickness.

The inventors have recognized that there is a significant challenge in achieving a stable and uniform coating of recognition elements such as biological recognition elements (e.g., antibodies, aptamers, peptides) on the capacitor electrodes for detection of biomolecules. This is especially the case for vertical side walls of the nanogap (<1 μm) in the capacitor electrodes, where it is difficult for the biological recognition elements to penetrate the nanogap structures to cover the vertical side walls of the capacitor electrodes.

A uniform coating of biological recognition elements on nanogap electrodes, e.g., nanogap-interdigitated electrodes (nIDEs) currently known in the art, is important for achieving selective and efficient detection of biomolecules of interest. A non-uniform or underfilled coating of biological recognition elements reduces the overall capacitance of the biosensor, resulting in diminished sensitivity and resolution of detection of the biomolecules of interest, as well as longer incubation times for coating. Factors affecting the uniformity of the coating include hydrophobicity of the electrode surface, viscosity of the coating composition containing the biological recognition element, structure size, and repulsive steric effect etc. Notedly, biosensors used for detection of charged particles such as DNA, RNA, other nucleic acids, etc. produce repulsive steric effect, thus, preventing the molecules entering the nanogap structure. Often, it results in the obstruction of the antibodies at the top opening of the nanogap structure.

Existing techniques for fabrication of biosensors include surface plasma treatment, spin coating of functionalized linkers, and groove structure electrodes. However, surface plasma treatment has a relatively low effect on the wettability of the side walls of the nanogap and the surface of the electrodes rapidly reacts with oxygen. Achieving uniform plasma treatment across large or irregularly shaped substrates can be challenging. Variations in plasma density and exposure time may result in non-uniform surface modification, affecting the reproducibility of results. Spin coating of functionalized linkers ensures only the conformal coating of a surface modification layer but may result in non-uniform deposition of functionalized linkers, especially on non-flat or irregularly shaped substrates. This non-uniformity can impact the coverage and density of immobilized biomolecules, affecting the performance of the biosensor. Groove structure electrodes may result in a non-uniform electric field within the nanogap, thereby reducing the sensitivity of the biosensor.

Thus, there is a need for a nanogap electrode device, a method of making a nanogap electrode device, and a sensor for detecting a target analyte, which seeks to address or at least ameliorate one of the above problems.

### SUMMARY

In accordance with a first aspect of the present disclosure, there is provided a nanogap electrode device comprising, a first electrode and a second electrode spaced apart from each other, said first and second electrodes defining a first region and a second region; wherein the first region comprises a first gap between the first electrode and the second electrode, said first gap having a first gap length and a first gap width; wherein the second region comprises a second gap between the first electrode and the second electrode, said second gap having a second gap length and a second gap width; and wherein the second gap length and second gap width are greater than the first gap width.

In the nanogap electrode device as disclosed herein, the second gap width may be greater than the first gap width by a factor of from 3.75 to 60.

In the nanogap electrode device as disclosed herein, the first gap width may fall in a range of from 50 nm to 400 nm, and the second gap width may fall in a range of from 1500 nm to 3000 nm.

In the nanogap electrode device as disclosed herein, the first gap length may fall in a range of from 600 nm to 1000 nm, and the second gap length may fall in a range of from 500 nm to 900 nm.

The nanogap electrode device may further comprise a plurality of alternating first and second regions defined by the first and second electrodes.

In the nanogap electrode device as disclosed herein, the first region may comprise a sensing region having an area defined by the first gap length and the first gap width.

In the nanogap electrode device as disclosed herein, the second region may comprise a reservoir region having an area defined by the second gap length and the second gap width.

The nanogap electrode device may further comprise a surface modification layer substantially uniformly disposed on the first and second electrodes; and a layer of biomolecules substantially uniformly disposed on the surface modification layer.

In the nanogap electrode device as disclosed herein, the first and second electrodes may each comprise a continuous length of material arranged to form a plurality of horizontal members and a plurality of lateral members; wherein each one of the plurality of horizontal members of the first electrode has a corresponding horizontal member of the second electrode which is substantially parallel to each other, and each horizontal member comprises a first end and a second end; and wherein the plurality of lateral members is orthogonally arranged with respect to the plurality of horizontal members, and each lateral member either connects the first ends of two adjacent horizontal members or the second ends of two adjacent horizontal members.

In the nanogap electrode device as disclosed herein, the horizontal member may have a length falling in a range of from 400 nm to 1200 nm, and the lateral member may have a length falling in a range of from 600 nm to 1400 nm.

In accordance with a second aspect of the present disclosure, there is provided a method of making a nanogap electrode device, the method comprising, providing a first electrode and a second electrode spaced apart from each other, said first and second electrodes defining a first region and a second region, forming a first gap between the first electrode and the second electrode in the first region, said first gap having a first gap length and a first gap width; forming a second gap between the first electrode and the second electrode in the second region, said second gap having a second gap length and a second gap width; wherein the second gap length and second gap width are greater than the first gap width.

In the method as disclosed herein, the second gap width may be greater than the first gap width by a factor of from 3.75 to 60.

In the method as disclosed herein, the first gap width may fall in a range of from 50 nm to 400 nm, and the second gap width may fall in a range of from 1500 nm to 3000 nm.

In the method as disclosed herein, the first gap length may fall within a range of from 600 nm to 1000 nm, and the second gap length may fall within a range of from 500 nm to 900 nm.

The method may further comprise providing a plurality of alternating first and second regions defined by the first and second electrodes.

In the method as disclosed herein, providing the first and second electrodes may comprise forming a sensing region having an area defined by the first gap length and the first gap width.

In the method as disclosed herein, providing the first and second electrodes may comprise forming a reservoir region having an area defined by the second gap length and the second gap width.

The method may further comprise providing a surface modification layer substantially uniformly disposed on the first and second electrodes; and providing a layer of biomolecules substantially uniformly disposed on the surface modification layer.

In the method as disclosed herein, providing the first and second electrodes may comprise providing a continuous length of material for each of the first and second electrodes, said continuous length of material arranged to form a plurality of horizontal members and a plurality of lateral members; wherein each one of the plurality of horizontal members of the first electrode has a corresponding horizontal member of the second electrode which is substantially parallel to each other, and each horizontal member comprises a first end and a second end; and wherein the plurality of lateral members is orthogonally arranged with respect to the plurality of horizontal members, and each lateral member either connects the first ends of two adjacent horizontal members or the second ends of two adjacent horizontal members.

In the method as disclosed herein, the horizontal member may have a length falling in a range of from 400 nm to 1200 nm, and the lateral member may have a length falling in a range of from 600 nm to 1400 nm.

In accordance with a third aspect of the present disclosure, there is provided a sensor for detecting a target analyte, said sensor comprising, a nanogap electrode device comprising, a first electrode and a second electrode spaced apart from each other, said first and second electrodes defining a first region and a second region; wherein the first region comprises a first gap between the first electrode and the second electrode, said first gap having a first gap length and a first gap width; wherein the second region comprises a second gap between the first electrode and the second electrode, said second gap having a second gap length and a second gap width; and wherein the second gap length and second gap width are greater than the first gap width.

### BRIEF DESCRIPTION OF THE DRAWINGS

Exemplary embodiments of the invention will be better understood and readily apparent to one of ordinary skill in the art from the following written description, by way of example only, and in conjunction with the drawings, in which:

FIG. 1 is a schematic diagram of a nanogap electrode device in an example embodiment.

FIG. 2 is a schematic diagram of a nanogap electrode device in another example embodiment.

FIG. 3A is a first schematic diagram of a process of applying a coating composition onto a nanogap electrode device in an example embodiment.

FIG. 3B is a second schematic diagram of the process of applying the coating composition onto the nanogap electrode device in the example embodiment.

FIG. 3C is a third schematic diagram of the process of applying the coating composition onto the nanogap electrode device in the example embodiment.

FIG. 3D is a fourth schematic diagram of the process of applying the coating composition onto the nanogap electrode device in the example embodiment.

FIG. 4 is a schematic diagram of a nanogap-interdigitated electrode (nIDE) in a comparative example embodiment.

FIG. 5A is a first schematic diagram of a process of applying a coating composition onto a nIDE in a comparative example embodiment.

FIG. 5B is a second schematic diagram of the process of applying the coating composition onto the nIDE in the comparative example embodiment.

FIG. 5C is a third schematic diagram of the process of applying the coating composition onto the nIDE in the comparative example embodiment.

FIG. 5D is a fourth schematic diagram of the process of applying the coating composition onto the nIDE in the comparative example embodiment.

FIG. 6A is an electrode design simulation result showing a top view of a nanogap electrode device in an example embodiment.

FIG. 6B is an electrode design simulation result showing a bottom view of the nanogap electrode device in the example embodiment.

FIG. 6C is an electric potential simulation result of the nanogap electrode device in the example embodiment.

FIG. 7A is an electrode design simulation result showing a top view of a nIDE in a comparative example embodiment.

FIG. 7B is an electrode design simulation result showing a bottom view of the nIDE in the comparative example embodiment.

FIG. 7C is an electric potential simulation result of the nIDE in the comparative example embodiment.

FIG. 8 is a chart showing capacitance curves versus the gap size for the nanogap electrode device and nIDE.

FIG. 9 is a schematic flowchart for illustrating a method of making a nanogap electrode device in an example embodiment.

### DETAILED DESCRIPTION

Example, non-limiting embodiments may provide a nanogap electrode device, a method of making a nanogap electrode device, and a sensor for detecting a target analyte. In various embodiments, unless otherwise stated, the term “horizontal” as used herein is intended to describe a direction or an orientation substantially parallel to the X axis, the term “lateral” as used herein is intended to describe a direction or an orientation substantially parallel to the Y axis, and the term “vertical” as used herein is intended to describe a direction or orientation substantially parallel to the Z axis. In various embodiments, the horizontal plane of a substrate is substantially parallel to the X-Y plane. In various embodiments, a horizontal member of the nanogap electrode device is orientated substantially parallel to the X axis. In various embodiments, a lateral member of the nanogap electrode device is orientated substantially parallel to the Y axis. In various embodiments, horizontal and lateral members of the nanogap electrode device are substantially parallel to the X-Y plane.

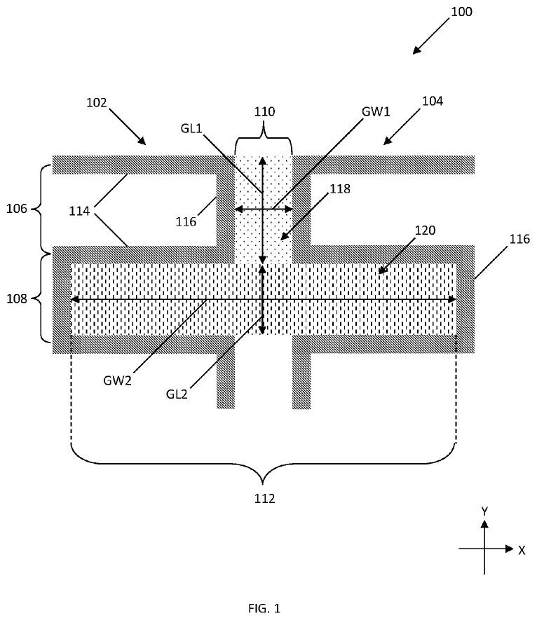

FIG. 1 is a schematic diagram of a nanogap electrode device 100 in an example embodiment. The nanogap electrode device 100 comprises a first electrode/conductive element 102 and a second electrode/conductive element 104 spaced apart from each other, said first and second electrodes 102, 104 defining a first region 106 and a second region 108; wherein the first region 106 comprises a first gap 110 between the first electrode 102 and the second electrode 104, said first gap 110 having a first gap length GL1 and a first gap width GW1; wherein the second region 108 comprises a second gap 112 between the first electrode 102 and the second electrode 104, said second gap 112 comprising a second gap length GL2 and a second gap width GW2; and wherein the second gap length GL2 and second gap width GW2 are greater than the first gap width GW1.

In the example embodiment, the first region 106 is next (i.e., immediately adjacent) to the second region 108. In the example embodiment, the first electrode 102 is spaced further apart from the second electrode 104 in the second region 108 than in the first region 106. In the example embodiment, the first electrode 102 and second electrode 104 are positioned close to each other, such that the first gap length GL1 and first gap width GW1 are on the scale of nanometers. The term “nano” as used herein is to be interpreted broadly to include dimensions no more than about 1000 nm. In other words, the first gap 110 is a nanogap. It will be appreciated that the nanogap electrode device is not limited to a single first region 106 and second region 108 of the first and second electrodes 102, 104 as shown in FIG. 1. In some embodiments, the nanogap electrode device may comprise more than one first region 106 and more than one second region 108 of the first and second electrodes 102, 104. In some embodiments, the nanogap electrode device may comprise a plurality of alternating first and second regions 106, 108 of the first and second electrodes 102, 104.

In the example embodiment, the first electrode 102 and second electrode 104 each comprises a continuous length of conductive material arranged to form a plurality of horizontal members, e.g., 114, and a plurality of lateral members, e.g., 116. Each one of the plurality of horizontal members, e.g., 114, of the first electrode 102 has a corresponding horizontal member, e.g., 114, of the second electrode 104 which is substantially parallel to each other. The plurality of horizontal members, e.g., 114, may be arranged to be substantially parallel to one another. Each horizontal member 114 comprises a first (left) end and a second (right) end. The plurality of lateral members, e.g., 116, are orthogonally arranged with respect to the plurality of horizontal members, e.g., 114. Each lateral member 116 either connects the respective first ends of two adjacent horizontal members, e.g., 114, or the respective second ends of two adjacent horizontal members, e.g., 114. The first and second electrodes 102, 104 may have a defined thickness or depth (i.e., a dimension of the first and second electrode 102, 104 that is in a direction perpendicular to a surface on which the electrode is disposed, e.g., substrate surface).

In the example embodiment, the first gap length GL1 is defined as a distance along opposing surfaces of the first and second electrodes 102, 104 defining the first region 106. In the example embodiment, the first gap width GW1 is defined as a distance between opposing surfaces of the first and second electrodes 102, 104 defining the first region 106. In the example embodiment, the opposing surfaces of the first and second electrodes 102, 104 in the first gap 110 may be substantially parallel to each other. In the example embodiment, the second gap length GL2 is defined as a distance along opposing surfaces of the first and second electrodes 102, 104 defining the second region 108. In the example embodiment, the second gap width GW2 is defined as a distance between opposing surfaces of the first and second electrodes 102, 104 defining the second region 108. In the example embodiment, the opposing surfaces of the first and second electrodes 102, 104 in the second gap 112 may be substantially parallel to each other.

In the example embodiment, the first region 106 comprises a sensing region 118 having an area defined by the first gap length GL1 and the first gap width GW1 (see area marked by dots). The sensing region 118 is a space defined between a lateral member 116 of the first electrode 102 and a lateral member 116 of the second electrode 104 in the first region 106. The sensing region 118 has a volume which may be defined by the product of the first gap length GL1, first gap width GW1 and thickness/depth of the first and second electrodes 102, 104 in the first region 106 (i.e., GL1×GW1×Thickness). The lateral members 116 of the first and second electrodes 102, 104 are substantially parallel to each other, with opposing surfaces (i.e., vertical side walls) facing each other.

In the example embodiment, the sensing region 118 is configured for capacitive sensing by utilizing changes in capacitance that occur within the sensing region 118 in response to binding of molecules of a target analyte (e.g., biomolecules). The surfaces of the first and second electrodes 102, 104 may be functionalized by immobilizing recognition elements such as biological recognition elements, to enable specific binding of the target analyte. Examples of biological recognition elements include but are not limited to aptamer, antibody, enzyme, nucleic acid such as DNA probe, RNA probe, and peptide. Examples of biomolecular target analytes include but are not limited to antigen, complementary DNA, complementary RNA, and enzyme substrate. When a sample containing the target analyte is introduced to a sensor comprising the nanogap electrode device 100, the target analyte molecules selectively bind to the recognition elements immobilized on the electrode surface within the sensing region 118. The binding of target analyte molecules to the electrode surface causes a change in the dielectric properties of the sensing region 118, leading to a change in capacitance.

In the example embodiment, the capacitance between the first and second electrodes 102, 104 is inversely proportional to the first gap width GW1. A smaller first gap width GW1 leads to a higher capacitance, whereas a larger first gap width GW1 leads to a lower capacitance. A smaller first gap width GW1 may facilitate a stronger electric field between the first and second electrodes 102, 104, thereby resulting in a higher capacitance as more electrical charge can be stored. In the example embodiment, the first gap width GW1 is specifically selected to maximize sensitivity and specificity of the nanogap electrode device 100 for detecting the target analyte. Advantageously, by controlling the first gap width GW1, the nanogap electrode device 100 may achieve higher sensitivity to changes in the dielectric constant of the medium caused by biomolecular interactions. Relatively small changes in the first gap width GW1 may result in significant changes in capacitance, allowing for the detection and measurement of target analytes with higher sensitivity.

In the example embodiment, the first gap width GW1 is substantially perpendicular to the opposing surfaces of the lateral members 116 of the first and second electrodes 102, 104, defining the first region 106. In the example embodiment, the first gap length GL1 is substantially parallel to the opposing surfaces of the lateral members 116 of the first and second electrodes 102, 104, defining the first region 106. The first gap width GW1 may fall in a range of from about 50 nm to about 400 nm. The first gap width GW1 may fall in a range with start and end values selected from the following group of numbers: 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, and 400 nm. The first gap length GL1 may fall in a range of from about 600 nm to about 1000 nm. The first gap length GL1 may fall in a range with start and end values selected from the following group of numbers: 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, and 1000 nm.

In the example embodiment, the second region 108 comprises a reservoir region 120 having an area defined by the second gap length GL2 and the second gap width GW2 (see area marked by dashed lines). The reservoir region 120 is a space defined by two horizontal members 114 of the first electrode 102 having the first (left) ends connected by a lateral member 116, and two horizontal members 114 of the second electrode 104 having the second (right) ends connected by a lateral member 116. The reservoir region 120 has a volume which may be defined by the product of the second gap length GL2, second gap width GW2 and thickness/depth of the first and second electrodes 102, 104 in the second region 108 (i.e., GL2 ×GW2×Thickness). The second gap length GL2 and the second gap width GW2 are greater than the first gap width GW1 to ensure that the reservoir region 120 has sufficient capacity for accumulation of a coating composition.

In the example embodiment, the reservoir region 120 is configured for facilitating a substantially uniform coating of recognition element (e.g., biological recognition element) on the first and second electrodes 102, 104. In the example embodiment, the reservoir region 120 has a relatively larger volume as compared to the sensing region 118. The relatively larger reservoir region 120 as compared to the sensing region 118 may allow for accumulation of a coating material/coating composition containing the biological recognition elements to be coated onto the first and second electrodes 102, 104, and promote nanocapillary effect to diffuse the coating composition into the relatively smaller sensing region 118. Such a configuration of the first and second electrodes 102, 104 may advantageously facilitate top-down deposition of the coating composition and improve penetration of the coating composition into the sensing region 118, thereby improving coverage of the biological recognition element across vertical side walls of the first and second electrodes 102, 104 in the first gap 110.

In the example embodiment, the second gap width GW2 is substantially perpendicular to the opposing surfaces of the lateral members 116 of the first and second electrodes 102, 104, defining the second region 108. In the example embodiment, the second gap length GL2 is substantially parallel to the opposing surfaces of the lateral members 116 of the first and second electrodes 102, 104, defining the second region 108. In the example embodiment, the second gap width GW2 may fall in a range of from about 1500 nm to about 3000 nm. The second gap width GW2 may fall in a range with start and end values selected from the following group of numbers: 1500, 1550, 1600, 1650, 1700, 1750, 1800, 1850, 1900, 1950, 2000, 2050, 2100, 2150, 2200, 2250, 2300, 2350, 2400, 2450, 2500, 2550, 2600, 2650, 2700, 2750, 2800, 2850, 2900, 2950, and 3000 nm. In the example embodiment, the second gap length GL2 may fall in a range of from about 500 nm to about 900 nm. The second gap length GL2 may fall in a range with start and end values selected from the following group of numbers: 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, and 900 nm.

In the example embodiment, the second gap width GW2 is larger than the first gap width GW1. In the example embodiment, the second gap width GW2 may be larger than the first gap width GW1 by a factor of from about 3.75 to about 60, from about 5 to about 59, from about 6 to about 58, from about 7 to about 57, from about 8 to about 56, from about 9 to about 55, from about 10 to about 54, from about 11 to about 53, from about 12 to about 52, from about 13 to about 51, from about 14 to about 50, from about 15 to about 49, from about 16 to about 48, from about 17 to about 47, from about 18 to about 46, from about 19 to about 45, from about 20 to about 44, from about 21 to about 43, from about 22 to about 42, from about 23 to about 41, from about 24 to about 40, from about 25 to about 39, from about 26 to about 38, from about 27 to about 37, from about 28 to about 36, from about 29 to about 35, from about 30 to about 34, from about 31 to about 33, or from about 32 to about 33. For example, where a first gap width GW1 is about 50 nm, a second gap width GW2 of about 1500 nm is larger than the first gap width GW1 by a factor of about 30.

In the example embodiment, the first gap length GL1 is larger than the second gap length GL2. In the example embodiment, the first gap length GL1 may be larger than the second gap length GL2 by a factor of from about 1.2 to about 2, from about 1.2 to about 1.9, from about 1.3 to about 1.8, from about 1.4 to about 1.7, or from about 1.5 to about 1.6. For example, where a second gap length GL2 is about 500 nm, a first gap length GL1 of about 600 nm is larger than the second gap length GL2 by a factor of about 1.2.

In the example embodiment, the second gap length GL2 is larger than the first gap width GW1. In the example embodiment, the second gap length GL2 may be larger than the first gap width GW1 by a factor of from about 1.25 to about 18, from about 2 to about 17, from about 3 to about 16, from about 4 to about 15, from about 5 to about 14, from about 6 to about 13, from about 7 to about 12, from about 8 to about 11, or from about 9 to about 10. For example, where a first gap width GW1 is about 50 nm, a second gap length GL2 of about 500 nm is larger than the first gap width GW1 by a factor of about 10.

In the example embodiment, the configuration of the electrodes allows the nanogap electrode device 100 to be used in various sensing applications due to its relatively high sensitivity, precise control over its sensing region, and ability to detect minute changes in electrical properties within the narrow nanogap. The nanogap electrode device 100 may be utilized in applications including but not limited to biosensing, gas sensing, and chemical sensing. For example, the nanogap electrode device 100 may be utilized in a biosensor for label-free detection of biomolecules (e.g., DNA, proteins, antibodies, and enzymes). For example, the nanogap electrode device 100 may be utilized in aptamer-based in-vitro devices (IVDs). The nanogap allows for direct electrical detection of biomolecular interactions, enabling sensitive and selective biosensing platforms for medical diagnostics, disease monitoring, and drug discovery.

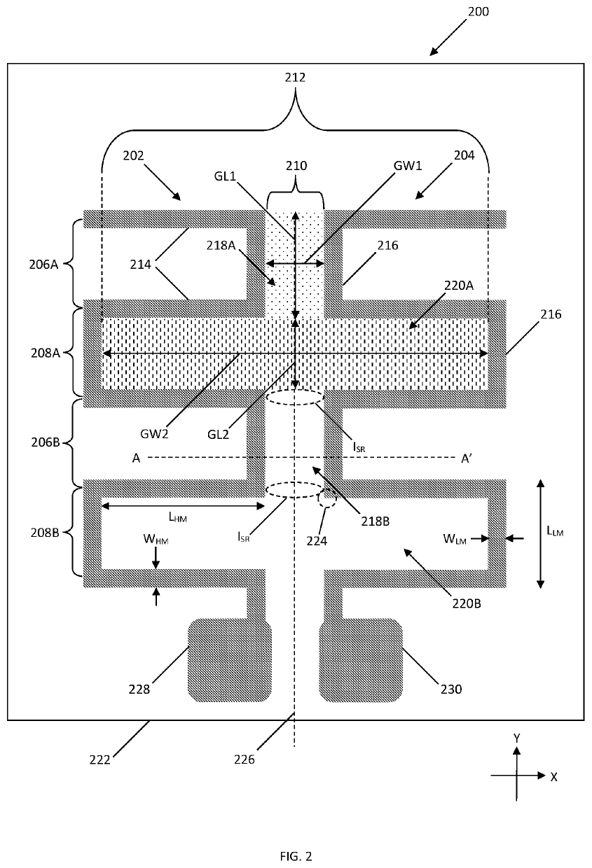

FIG. 2 is a schematic diagram of a nanogap electrode device 200 in another example embodiment. The nanogap electrode device 200 of FIG. 2 is constructed in a similar manner as the nanogap electrode device 100 of FIG. 1. The nanogap electrode device 200 comprises a first electrode 202 and a second electrode 204 spaced apart from each other, said first and second electrodes 202, 204 defining at least one first region e.g., 206A and at least one second region e.g., 208A; wherein the first region e.g., 206A comprises a first gap 210 between the first electrode 202 and the second electrode 204, said first gap 210 having a first gap length GL1 and a first gap width GW1; wherein the second region e.g., 208A comprises a second gap 212 between the first electrode 202 and the second electrode 204, said second gap 212 comprising a second gap length GL2 and a second gap width GW2; and wherein the second gap length GL2 and second gap width GW2 are greater than the first gap width GW1.

In the example embodiment, the first and second electrodes 202, 204 further define a plurality of alternating first and second regions. As shown in FIG. 2, the nanogap electrode device 200 comprises a first region 206A, followed by a second region 208A, followed by another first region 206B, and followed by another second region 208B defined by the first and second electrodes 202, 204.

In the example embodiment, the nanogap electrode device 200 further comprise a substrate 222 onto which the first and second electrodes 202, 204 are disposed. The substrate 222 may be planar or non-planar. The first and second electrodes 202, 204 may be made from metals, including but not limited to gold, platinum, silver, or a combination thereof. The substrate 222 may be a solid material, including but not limited to glass, silicon, polymer, or a combination thereof. The electrode material may be deposited onto the substrate 222 using metal deposition process techniques known in the art, including but not limited to physical vapor deposition such as sputtering. The specific shape and geometry of the first and second electrodes 202, 204 may be defined using patterning techniques known in the art, including but not limited to electron beam lithography, nanoimprint lithography, electrodeposition, and the like.

In the example embodiment, the first and second electrodes 202, 204 are disposed/deposited on the substrate 222 in a specific shape, pattern and/or geometry to satisfy the requirements of having different regions comprising gaps with different gap lengths and widths. In the example embodiment, the first and second electrodes 202, 204 each comprises a continuous length of material arranged to form a plurality of horizontal members, e.g., 214, and a plurality of lateral members, e.g., 216. Each one of the plurality of horizontal members, e.g., 214, of the first electrode 202 has a corresponding horizontal member, e.g., 214, of the second electrode 204 which is substantially parallel to each other. The plurality of horizontal members, e.g., 214, may be arranged to be substantially parallel to one another. Each horizontal member 214 comprises a first (left) end and a second (right) end. The plurality of lateral members, e.g., 216, are orthogonally arranged with respect to the plurality of horizontal members, e.g., 214. Each lateral member 216 either connects the first ends of two adjacent horizontal members, e.g., 214, or the second ends of two adjacent horizontal members, e.g., 216. The first and second electrodes 202, 204 may have a defined thickness or depth (i.e., a dimension of the first and second electrodes 202, 204 in a direction perpendicular to the horizontal plane of the substrate 222).

In the example embodiment, the first gap length GL1 is defined as a distance along opposing surfaces of the first and second electrodes 202, 204 defining the first region e.g., 206A. In the example embodiment, the first gap width GW1 is defined as a distance between opposing surfaces of the first and second electrodes 202, 204 defining the first region e.g., 206A. In the example embodiment, the opposing surfaces of the first and second electrodes 202, 204 in the first gap 210 may be substantially parallel to each other. In the example embodiment, the second gap length GL2 is defined as a distance along opposing surfaces of the first and second electrodes 202, 204 defining the second region e.g., 208A. In the example embodiment, the second gap width GW2 is defined as a distance between opposing surfaces of the first and second electrodes 202, 204 defining the second region e.g., 208A. In the example embodiment, the opposing surfaces of the first and second electrodes 202, 204 in the second gap 212 may be substantially parallel to each other.

In the example embodiment, the first region e.g., 206A comprises a sensing region 218A having an area defined by the first gap length GL1 and the first gap width GW1 (see area marked by dots). In the example embodiment, the second region e.g., 208A comprises a reservoir region 220A having an area defined by the second gap length GL2 and the second gap width GW2. As shown in FIG. 2, the area of the reservoir region e.g., 220A is larger than the area of the sensing region e.g., 218A due to the larger second gap length GL2 and second gap width GW2 relative to the first gap width GW1. The reservoir region e.g., 220A is immediately adjacent to the sensing region e.g., 218A. During fabrication of the nanogap electrode device 200, sensing surfaces of the first and second electrodes 202, 204 may be functionalized by attaching/immobilizing biological recognition elements thereon. The larger reservoir region 220 helps to accumulate a coating composition containing the biological recognition elements and to promote movement/diffusion of the coating composition into the narrower sensing region e.g., 218A via nanocapillary effect, thereby allowing a substantially uniform layer of the biological recognition elements to cover vertical side walls (i.e., surfaces of the first and second electrodes 202, 204 that are substantially parallel to, and facing each other) of the first gap 210.

In the example embodiment, the horizontal member 214 may have a length L_{HM} falling in a range of from about 400 nm to about 1200 nm. The lateral member 216 may have a length L_{LM} falling in a range of from about 600 nm to about 1400 nm. The length L_{HM} of the horizontal member 214 may fall in a range with start and end values selected from the following group of numbers: 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770 , 780, 790, 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, 1100, 1110, 1120, 1130, 1140, 1150, 1160, 1170, 1180, 1190, and 1200 nm. The length L_{LM} of the lateral member 216 may fall in a range with start and end values selected from the following group of numbers: 600, 610, 620, 630, 640, 650, 660, 670, 680, 690, 700, 710, 720, 730, 740, 750, 760 ,770, 780, 790, 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, 1100, 1110, 1120, 1130, 1140, 1150, 1160, 1170, 1180, 1190, 1200, 1210, 1220, 1230, 1240, 1250, 1260, 1270, 1280, 1290, 1300, 1310, 1320, 1330, 1340, 1350, 1360, 1370, 1380, 1390, and 1400 nm.

In the example embodiment, the horizontal member 214 may have a width W_{HM} falling in a range of from about 50 nm to about 200 nm. The lateral member 216 may have a width W_{LM} falling in a range of from about 50 nm to about 200 nm. The width W_{HM} of the horizontal member 214 may fall in a range with start and end values selected from the following group of numbers: 50, 60, 70, 80, 90, 100, 110, 120, 130, 140, 150, 160, 170, 180, 190, and 200 nm. The width W_{LM} of the lateral member 216 may fall in a range with start and end values selected from the following group of numbers: 50, 60, 70, 80, 90, 100, 110, 120, 130, 140, 150, 160, 170, 180, 190, and 200 nm.

In the example embodiment, the first and second electrodes 202, 204 may have a thickness falling in a range of from about 200 nm to about 600 nm. The thickness of the first and second electrodes 202, 204 may fall in a range with start and end values selected from the following group of numbers: 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, and 600 nm.

In one embodiment, the length L_{HM} of the horizontal member 214 is about 400 nm, the width W_{HM} of the horizontal member 214 is about 200 nm, the first gap width GW1 is about 200 nm, and the thickness of the first and second electrodes 202, 204 is about 600 nm.

In the example embodiment, the first region e.g., 206B may comprise at least one inlet I_{SR} to the sensing region 218B. The inlet I_{SR} may be disposed at an interface between the sensing region 218B and adjacent reservoir regions 220A and 220B. As shown in FIG. 2, the first region 206B comprises two inlets I_{SR} to the sensing region 218B (see area marked by ovals in dotted lines). In the example embodiment, the first electrode 202 and/or second electrode 204 at the inlet I_{SR} to the sensing region 218B may be planar or curved. In other words, the joint section 224 of the horizontal member 214 and lateral member 216 at the inlet I_{SR} may have an angular edge or a curved/rounded edge. In the example embodiment, the lateral members 216 of the first electrode 202 and/or second electrode 204 in the sensing region 218B may be planar or curved.

In the example embodiment, the second electrode 204 may be a mirror image of the first electrode 202 about an axis 226 passing through the first and second gaps 210, 212. In the example embodiment, the first and second electrodes 202, 204 have identical patterns that are mirror images of each other and facing opposite directions. In other words, the first and second electrodes 202, 204 possess mirror symmetry but are not identical in their spatial arrangement.

In the example embodiment, the first and second electrodes 202, 204 may further comprise respective connection points/terminals 228, 230 for electrically connecting the electrodes to other components, e.g., electrical circuitry of a sensor. In the example embodiment, the nanogap electrode device 200 may be enclosed in a protective housing or casing to protect sensitive components from external factors and to provide a controlled environment for detection of biomolecules.

In the example embodiment, the nanogap electrode device 200 may further comprise a surface modification layer disposed over the first and second electrodes 202, 204. The surface modification layer may help to reduce incubation time for a coating composition containing the biological recognition element. A shorter incubation time may advantageously lower the risk of degradation of the biological recognition element. In addition, the surface modification layer may help to provide a conducive environment (e.g., biocompatible, hydrophilic, presence of functional groups for binding) for immobilization of recognition elements, e.g., biological recognition elements such as antibodies. Examples of surface modification include but are not limited to chemical functionalization, self-assembled monolayers (SAMs), biotin-streptavidin binding, and polymer coating.

In the example embodiment, the nanogap electrode device 200 may further comprise a layer of recognition elements. The layer of recognition elements may be disposed directly over the first and second electrodes 202, 204, or disposed over the surface modification layer. Examples of recognition elements include but are not limited to antibodies, aptamers, nucleic acids, and peptides. The presence of the recognition elements allows for selective detection of target analytes.

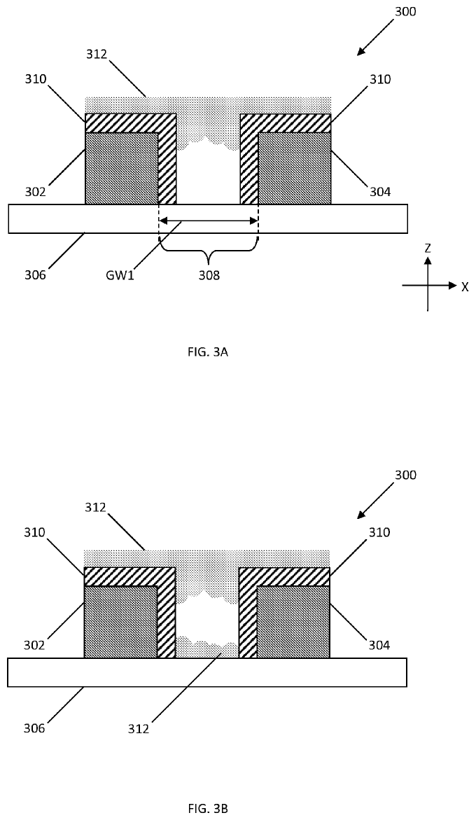

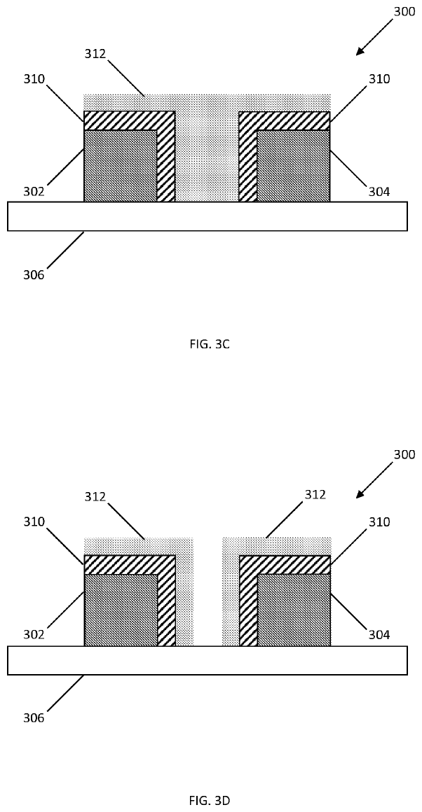

FIG. 3A to FIG. 3D are a series of schematic diagrams depicting a process of applying a coating composition 312 containing a biological recognition element (e.g., antibody coating) onto a nanogap electrode device 300 in an example embodiment. The nanogap electrode device 300 is structurally similar to the nanogap electrode device 200 of FIG. 2. FIG. 3A to FIG. 3D depict a cross-sectional view of the nanogap electrode device 300 that is structurally similar to a cross-sectional view of the nanogap electrode device 200 taken along the line A-A′ of FIG. 2.

FIG. 3A is a first schematic diagram of the process of applying the coating composition 312 onto the nanogap electrode device 300 in the example embodiment. The nanogap electrode device 300 comprises a first electrode 302 and a second electrode 304 disposed on a substrate 306 and spaced apart from each other. The nanogap electrode device 300 further comprises a first gap 308 between the first electrode 302 and the second electrode 304 having a first gap width GW1 defined between opposing surfaces (i.e., vertical side walls) of the first and second electrodes 302, 304 that are substantially parallel to, and facing each other. The space defined by the first gap 308 forms a sensing region of the nanogap electrode device 300 (compare 218B of FIG. 2). The first and second electrodes 302, 304 are coated with a surface modification layer 310 for reducing incubation time. As shown in FIG. 3A, when the coating composition 312 is applied from a top-down approach, the coating composition 312 fill the top of the first and second electrodes 302, 304 and penetration is relatively slower in the first gap 308.

FIG. 3B is a second schematic diagram of the process of applying the coating composition 312 onto the nanogap electrode device 300 in the example embodiment. Due to nano-capillary effect, the coating composition 312 from an adjacent reservoir region (compare 220A of FIG. 2) diffuses into the space of the first gap 308 (i.e., sensing region) via bottom-up filling.

FIG. 3C is a third schematic diagram of the process of applying the coating composition 312 onto the nanogap electrode device 300 in the example embodiment. Continuous diffusion of the coating composition 312 completely fills the narrow first gap 308 between the first and second electrodes 302, 304.

FIG. 3D is a fourth schematic diagram of the process of applying the coating composition 312 onto the nanogap electrode device 300 in the example embodiment. Post-rinsing with saline solution is performed to remove the biological recognition element that is not attached to the first and second electrodes 302, 304. A uniform coating of the biological recognition element across vertical side walls of the first and second electrodes 302, 304 is obtained. The nanogap electrode device 300 as shown in FIG. 3D represents the final product with an ideal coating of biological recognition element that is uniformly coated onto the electrodes with excellent coverage in the first gap 308.

In the example embodiment, the electrode structure of alternating large and narrow gaps between the electrodes advantageously improves the coverage of the biological recognition element, e.g., antibodies, on the side walls of the nanogap electrode device 300. The large gap helps to accumulate the antibody and promote the nanocapillary effect to diffuse the antibodies into the narrow gap area, while the nanogap area is mainly for capacitive sensing. Hence, this electrode structure could be used for high sensitivity detection of biomolecules.

The inventors recognized that the flow rate of the coating composition containing the biological recognition element is related to flow speed and gap distance between the electrodes. That is, flow rate of coating composition containing the biological recognition element, e.g., flow rate of antibody=flow speed×gap distance (i.e., GW1) between the electrodes. However, flow speed is related (i.e., inversely proportional) to viscosity of the coating composition, e.g., antibody (material property). When the coating composition is coated from the top-down approach, the large gap area (i.e., reservoir region) has an increased flow speed of the coating composition compared to the narrow gap (i.e., sensing region). Hence, the volume filled in the large gap area is fully filled, while the coating composition on the narrower gap is obstructed on the top region. With the fully filled antibody on the large gap area, the coating composition oozes into the narrow gap area due to nanocapillary effect. This nanocapillary effect is due to the free surface energy of the exposed coating composition at the junction of large and narrow gap. As the diffusion of the coating composition from the large gap into the narrow gap continues, lateral and top-down filling of the coating composition in the narrow gap area occur. Thus, the coating composition fully fills the gap between the electrodes in the structure. After a few hours of incubation, the electrodes are rinsed with saline solution to remove the biological recognition elements that are not bound to the surface modification layer.

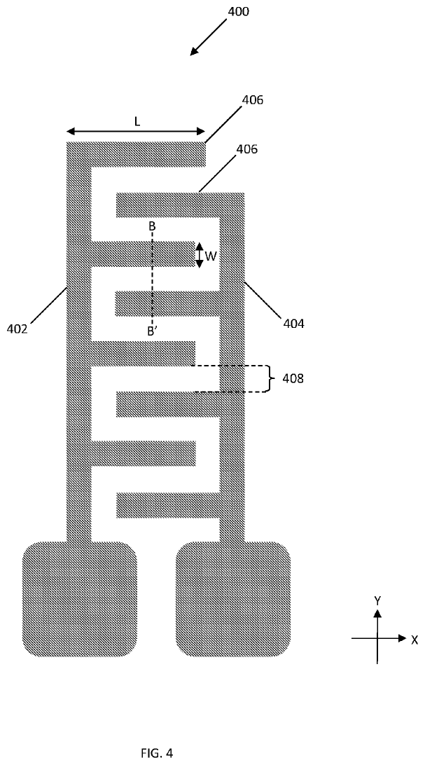

FIG. 4 is a schematic diagram of a nanogap-interdigitated electrode (nIDE) 400 in a comparative example embodiment. The nIDE electrode is an electrode configuration that is commonly used in the art for sensing applications, e.g., biosensing, chemical sensing and gas sensing. The nIDE 400 comprises a first electrode 402 and a second electrode 404, each electrode having a plurality of finger-like structures, e.g., 406. The first and second electrodes 402, 404 are configured such that the plurality of finger-like structures, e.g., 406 are arranged in an alternating interdigitated pattern with a gap 408 formed between adjacent finger-like structures e.g., 406. Each finger-like structure 406 has a length L_{nIDE} of about 400 nm and a width W_{nIDE} of about 200 nm. The gap 408 has a gap width GW_{nIDE} of about 200 nm. The first and second electrodes 402, 404 have a thickness of about 600 nm.

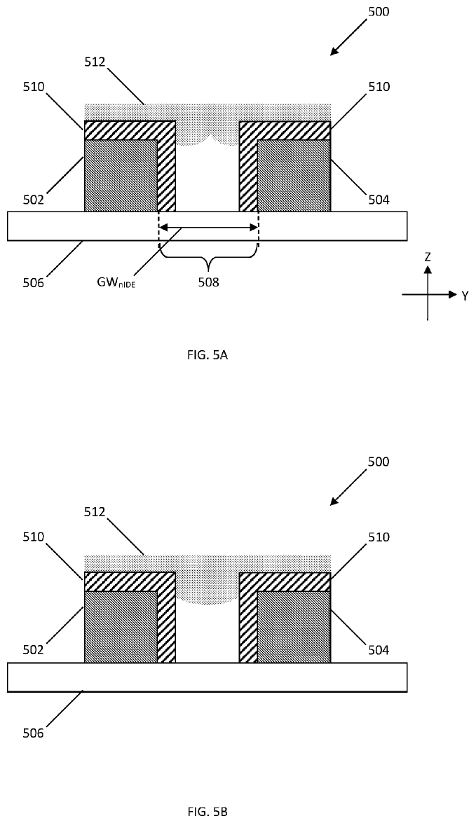

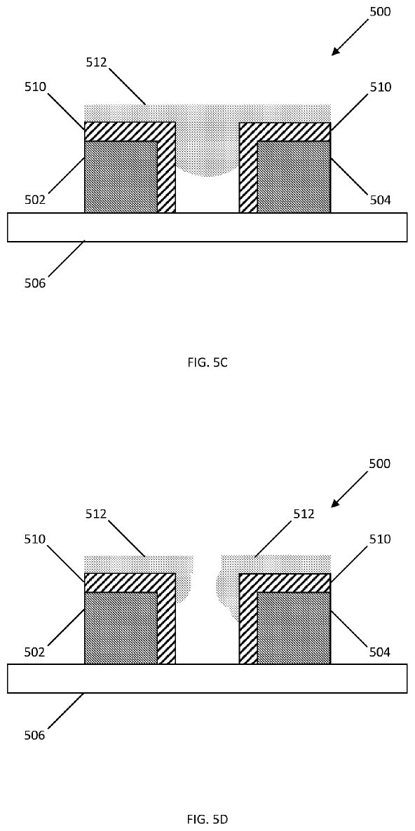

FIG. 5A to FIG. 5D are a series of schematic diagrams depicting a process of applying a coating composition 512 containing a biological recognition element (e.g., antibody coating) onto a nIDE 500 in a comparative example embodiment. The nIDE 500 is structurally similar to the nIDE 400 of FIG. 4. FIG. 5A to FIG. 5D depict a cross-sectional view of the nIDE 500 that is structurally similar to a cross-sectional view of the nIDE 400 taken along the line B-B′ of FIG. 4.

FIG. 5A is a first schematic diagram of the process of applying the coating composition 512 onto the nIDE 500 in the comparative example embodiment. The nIDE 500 comprises a first electrode 502 and a second electrode 504 disposed on a substrate 506 and spaced apart from each other. The nIDE 500 further comprises a gap 508 having a gap width GW_{nIDE} defined between surfaces of the first and second electrodes 502, 504 that are substantially parallel to, and facing each other. The first and second electrodes 502, 504 are coated with a surface modification layer 510 for reducing incubation time. As shown in FIG. 5A, when the coating composition 512 is applied from a top-down approach, the coating composition 512 fills the top of the first and second electrodes 502, 504 and penetration is relatively slower in the gap 508.

FIG. 5B is a second schematic diagram of the process of applying the coating composition 512 onto the nIDE 500 in the comparative example embodiment. Unlike the nanogap electrode device 300 where the coating composition 312 from an adjacent reservoir region (compare 220A of FIG. 2) diffuses into the space of the first gap 308 (i.e., sensing region) via bottom-up filling as shown in FIG. 3B, there is no bottom-up filling of the coating composition 512 in the gap 508 of the nIDE in FIG. 5B.

FIG. 5C is a third schematic diagram of the process of applying the coating composition 512 onto the nIDE 500 in the comparative example embodiment. Due to the lack of bottom-up filling and slow top-down penetration of the coating composition 512, a void with no coating composition 512 is formed in the gap 508.

FIG. 5D is a fourth schematic diagram of the process of applying the coating composition 512 onto the nIDE 500 in the comparative example embodiment. Post-rinsing with saline solution is performed to remove the biological recognition element that is not attached to the first and second electrodes 502, 504. As compared to FIG. 3D showing an ideal coating of the biological recognition element e.g., antibodies on the nanogap structure, the nIDE 500 in FIG. 5D has a non-uniform coating of the biological recognition element.

The comparative example embodiment demonstrates the challenges with the penetration of the antibodies (aptamers) into the nanogap structures to cover the vertical side walls of the nanogap electrodes of capacitive sensors. This is mainly due to the hydrophobicity of the electrode surface and viscosity of the antibody. Notedly, biosensors used for detection of charged particles such as DNA, RNA, other nucleic acids, etc. produce repulsive steric effect, thus, preventing the molecules entering the nanogap structure. Often, it results in the obstruction of the antibodies at the top opening of the nanogap structure as shown in FIG. 5D. With the nanogap electrodes being used for biosensing applications such as aptamer-based bio-sensing applications, this non-uniformity can impact the coverage and density of immobilized biomolecules, affecting the performance of the biosensor.

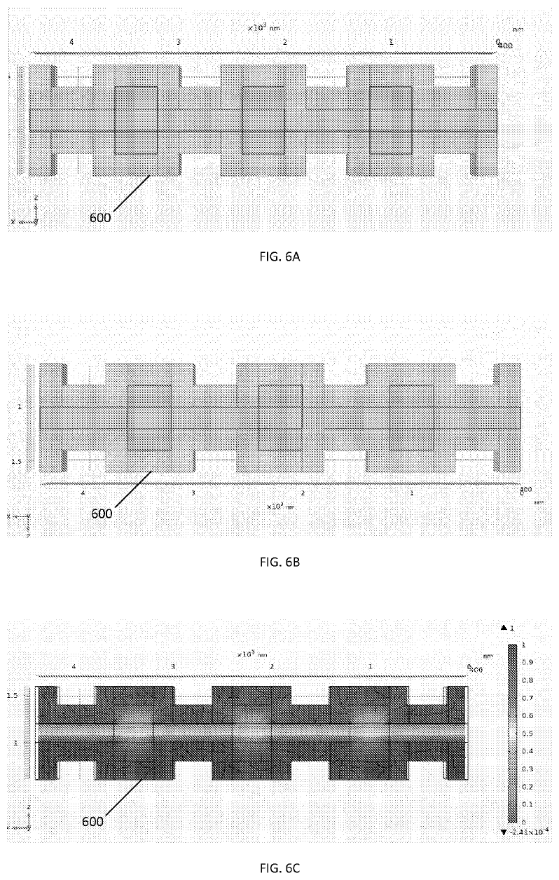

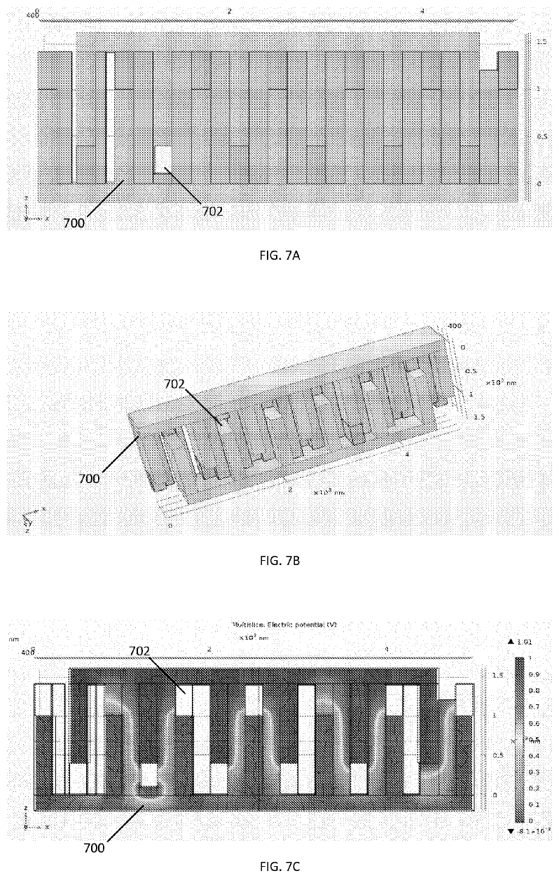

FIG. 6A-6C and FIG. 7A-7C show simulation results generated using the COMSOL software. Using this software, a nanogap electrode device 600 having a similar structure to the example embodiment shown in FIG. 2 is designed to have a thickness of 600 nm, a length of 600 nm, and a narrow gap between the electrodes with gap distance varied from 50 nm to 1000 nm. A nIDE 700 having a similar structure to the comparative example embodiment shown in FIG. 4 is designed to have a thickness of 600 nm, a length of 400 nm, and a gap between the electrodes of 200 nm. The nanogap electrode device 600 and nIDE 700 were subjected to electrode design simulation and electric potential simulation using the COMSOL software.

FIG. 6A is an electrode design simulation result showing a top view of the nanogap electrode device 600 in the example embodiment. FIG. 6B is an electrode design simulation result showing a bottom view of the nanogap electrode device 600 in the example embodiment. FIG. 6C is an electric potential simulation result of the nanogap electrode device 600 in the example embodiment. As shown in FIGS. 6A and 6B, the nanogap between the nanogap electrode device is uniformly and fully coated with an antibody coating. As shown in FIG. 6C, there is uniform energy distribution across the nanogap. The uniform coating enables the electrode structure to increase the energy distribution across the nanogap structure.

FIG. 7A is an electrode design simulation result showing a top view of the nIDE 700 in the comparative example embodiment. FIG. 7B is an electrode design simulation result showing a bottom view of the nIDE 700 in the comparative example embodiment. FIG. 7C is an electric potential simulation result of the nIDE 700 in the comparative example embodiment. As shown in FIGS. 7A and 7B, the nanogap between the nIDE is underfilled and not uniformly coated with the antibody coating (see underfilled regions labelled by reference numeral 702). As shown in FIG. 7C, there is reduced energy distribution due to the underfilling.

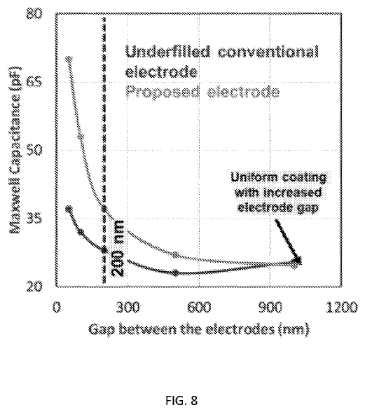

FIG. 8 is a chart showing Maxwell capacitance curves versus different gap sizes for the nanogap electrode device and nIDE. Maxwell's capacitance is calculated from electric potential energy. Based on the simulation results, it was observed that the presently disclosed nanogap electrode design improved the capacitance of the device by 90% by mitigation of underfilling of coating composition. Thus, the sensitivity of detection of biomolecules is increased for the nanogap capacitive electrodes. On the other hand, due to underfilling or non-uniform coating of the nIDE, the capacitance between the electrodes drops lower below ~30 Pf for <200 nm gap of electrode.

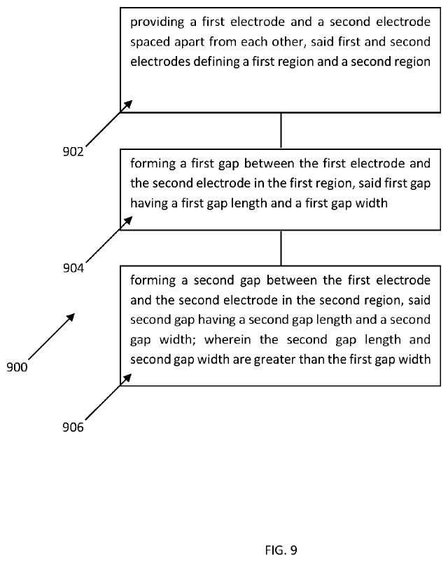

FIG. 9 is a schematic flowchart 900 for illustrating a method of making a nanogap electrode device in an example embodiment. At step 902, a first electrode and a second electrode spaced apart from each other are provided, said first and second electrodes defining a first region and a second region. At step 904, a first gap between the first electrode and the second electrode is formed in the first region, said first gap having a first gap length and a first gap width. At step 906, a second gap between the first electrode and the second electrode is formed in the second region, said second gap having a second gap length and a second gap width; wherein the second gap length and second gap width are greater than the first gap width.

In the described example embodiments, a nanogap electrode device having a unique pseudo-serpentine electrode structure is developed to improve the uniformity of a coating of biological recognition element (e.g., antibody) within the nanogap structure, for increasing the sensitivity and resolution of detection of biomolecules. In the described example embodiments, the electrode structure has alternate narrow first gaps and large second gaps. The narrow first gap is mainly for capacitive sensing of biomolecules. The large second gap enables the complete filling of a biological recognition element (e.g., antibody), as the antibody oozes into the underfilled narrow gap structure. In the described example embodiments, the alternate large and narrow gap electrodes for capacitive sensing of biomolecules help to increase the uniformity of coating of antibodies within the narrow gap of the electrodes. In the described example embodiments, the alternate large and narrow gap electrode structure with an antibody layer and surface modification layer helps to reduce the incubation time.

The terms “coupled” or “connected” as used in this description are intended to cover both directly connected or connected through one or more intermediate means, unless otherwise stated.

The description herein may be, in certain portions, explicitly or implicitly described as algorithms and/or functional operations that operate on data within a computer memory or an electronic circuit. These algorithmic descriptions and/or functional operations are usually used by those skilled in the information/data processing arts for efficient description. An algorithm is generally relating to a self-consistent sequence of steps leading to a desired result. The algorithmic steps can include physical manipulations of physical quantities, such as electrical, magnetic or optical signals capable of being stored, transmitted, transferred, combined, compared, and otherwise manipulated.

Further, unless specifically stated otherwise, and would ordinarily be apparent from the following, a person skilled in the art will appreciate that throughout the present specification, discussions utilizing terms such as “scanning”, “calculating”, “determining”, “replacing”, “generating”, “initializing”, “outputting”, and the like, refer to action and processes of an instructing processor/computer system, or similar electronic circuit/device/component, that manipulates/processes and transforms data represented as physical quantities within the described system into other data similarly represented as physical quantities within the system or other information storage, transmission or display devices etc.

The description also discloses relevant device/apparatus for performing the steps of the described methods. Such apparatus may be specifically constructed for the purposes of the methods, or may comprise a general purpose computer/processor or other device selectively activated or reconfigured by a computer program stored in a storage member. The algorithms and displays described herein are not inherently related to any particular computer or other apparatus. It is understood that general purpose devices/machines may be used in accordance with the teachings herein. Alternatively, the construction of a specialized device/apparatus to perform the method steps may be desired.

In addition, it is submitted that the description also implicitly covers a computer program, in that it would be clear that the steps of the methods described herein may be put into effect by computer code. It will be appreciated that a large variety of programming languages and coding can be used to implement the teachings of the description herein. Moreover, the computer program if applicable is not limited to any particular control flow and can use different control flows without departing from the scope of the invention.

Furthermore, one or more of the steps of the computer program if applicable may be performed in parallel and/or sequentially. Such a computer program if applicable may be stored on any computer readable medium. The computer readable medium may include storage devices such as magnetic or optical disks, memory chips, or other storage devices suitable for interfacing with a suitable reader/general purpose computer. In such instances, the computer readable storage medium is non-transitory. Such storage medium also covers all computer-readable media e.g. medium that stores data only for short periods of time and/or only in the presence of power, such as register memory, processor cache and Random Access Memory (RAM) and the like. The computer readable medium may even include a wired medium such as exemplified in the Internet system, or wireless medium such as exemplified in Bluetooth technology. The computer program when loaded and executed on a suitable reader effectively results in an apparatus that can implement the steps of the described methods.

The example embodiments may also be implemented as hardware modules. A module is a functional hardware unit designed for use with other components or modules. For example, a module may be implemented using digital or discrete electronic components, or it can form a portion of an entire electronic circuit such as an Application Specific Integrated Circuit (ASIC). A person skilled in the art will understand that the example embodiments can also be implemented as a combination of hardware and software modules.

Additionally, when describing some embodiments, the disclosure may have disclosed a method and/or process as a particular sequence of steps. However, unless otherwise required, it will be appreciated the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For an example, when “comprising” is used, reference to a “one” feature is also intended to be a reference to “at least one” of that feature. Terms such as “consisting”, “consist”, and the like, may, in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. The intention of the above specific disclosure is applicable to any depth/breadth of a range.

In the described example embodiments, the nanogap electrode device may be used in applications including but not limited to biosensing, gas sensing, and chemical sensing. Accordingly, there may be provided a sensor, e.g., capacitive biosensor and a method of using a sensor, said sensor comprising the nanogap electrode device as disclosed herein. The sensor may be used in various applications, including but not limited to medical diagnostics (e.g., point-of-care devices, in-vitro diagnostic (IVD) devices, implantable devices), environmental monitoring (e.g., water and air quality monitoring, detection of hazardous substances), food safety and quality control (e.g., detection of contaminants, monitoring various stages of food processing for quality control), biotechnology and drug development (e.g., drug screening, bioprocess monitoring) and the like.

In one example, there may be provided a sensor (e.g., capacitive biosensor) for detecting a target analyte (e.g., a biomolecule), said sensor comprising a nanogap electrode device comprising, a first electrode and a second electrode spaced apart from each other, said first and second electrodes defining a first region and a second region; wherein the first region comprises a first gap between the first electrode and the second electrode, said first gap having a first gap length and a first gap width; wherein the second region comprises a second gap between the first electrode and the second electrode, said second gap having a second gap length and a second gap width; and wherein the second gap length and second gap width are greater than the first gap width. The sensor may further comprise an electrical circuit coupled to respective connection terminals of the first and second electrodes for receiving electrical signals upon detection of a target analyte (e.g., a biomolecule) in one or more sensing regions of the first and second electrodes. The electrical circuit may be part of, or in communication with, a computer processor that is programmed to detect the target analyte or portion thereof from the electrical signals.

In another example, there may be provided a method of detecting a target analyte (e.g., a biomolecule), said method comprising, directing a biomolecule to a sensor comprising the nanogap electrode device as disclosed herein, wherein the nanogap electrode device comprises one or more sensing regions configured to allow the target analyte to flow through. The method may further comprise measuring electrical signals upon interaction of the target analyte with recognition elements in the sensing region; and detecting the target analyte using the measured electrical signals.

In the described example embodiments, the first region is described to be immediately adjacent to the second region of the nanogap electrode device. However, it will be appreciated the nanogap electrode device is not limited as such and may further comprise an intermediate region between the first and second regions.

In the described example embodiments, the first and second electrodes are described to have a pseudo-serpentine or meandering pattern as shown in the figures. However, it will be appreciated that the first and second electrodes are not limited as such and may have other shape, pattern and/or geometry that satisfy the gap length and gap width requirements of the first region comprising the first gap and the second region comprising the second gap as disclosed herein.

In the described example embodiments, the first and second electrodes define the second region or reservoir region to have a rectangular-shaped profile when viewed from the top of a substrate. However, it will be appreciated that the second region or reservoir region is not limited as such and may be defined to have other shapes, e.g., circular, elliptical shaped profiles. For example, the first and second electrodes may define the second region to have a circular profile when viewed from the top of the substrate. In this case, the second gap length and second gap width of the second region or reservoir region are defined as the diameter thereof.

It will be appreciated by a person skilled in the art that other variations and/or modifications may be made to the specific embodiments without departing from the scope of the invention as broadly described. For example, in the description herein, features of different exemplary embodiments may be mixed, combined, interchanged, incorporated, adopted, modified, included etc. or the like across different exemplary embodiments. The present embodiments are, therefore, to be considered in all respects to be illustrative and not restrictive.

1. A nanogap electrode device comprising,
a first electrode and a second electrode spaced apart from each other, said first and second electrodes defining a first region and a second region;
wherein the first region comprises a first gap between the first electrode and the second electrode, said first gap having a first gap length and a first gap width;
wherein the second region comprises a second gap between the first electrode and the second electrode, said second gap having a second gap length and a second gap width; and
wherein the second gap length and second gap width are greater than the first gap width.

2. The nanogap electrode device according to claim 1, wherein the second gap width is greater than the first gap width by a factor of from 3.75 to 60.

3. The nanogap electrode device according to claim 1, wherein the first gap width falls in a range of from 50 nm to 400 nm, and the second gap width falls in a range of from 1500 nm to 3000 nm.

4. The nanogap electrode device according to claim 1, wherein the first gap length falls in a range of from 600 nm to 1000 nm, and the second gap length falls in a range of from 500 nm to 900 nm.

5. The nanogap electrode device according to claim 1, further comprising a plurality of alternating first and second regions defined by the first and second electrodes.

6. The nanogap electrode device according to claim 1, wherein the first region comprises a sensing region having an area defined by the first gap length and the first gap width.

7. The nanogap electrode device according to claim 1, wherein the second region comprises a reservoir region having an area defined by the second gap length and the second gap width.

8. The nanogap electrode device according to claim 1, further comprising
a surface modification layer substantially uniformly disposed on the first and second electrodes; and
a layer of biomolecules substantially uniformly disposed on the surface modification layer.

9. The nanogap electrode device according to claim 1,
wherein the first and second electrodes each comprises a continuous length of material arranged to form a plurality of horizontal members and a plurality of lateral members;
wherein each one of the plurality of horizontal members of the first electrode has a corresponding horizontal member of the second electrode which is substantially parallel to each other, and each horizontal member comprises a first end and a second end; and
wherein the plurality of lateral members is orthogonally arranged with respect to the plurality of horizontal members, and each lateral member either connects the first ends of two adjacent horizontal members or the second ends of two adjacent horizontal members.

10. The nanogap electrode device according to claim 9, wherein the horizontal member has a length falling in a range of from 400 nm to 1200 nm, and the lateral member has a length falling in a range of from 600 nm to 1400 nm.

11. A method of making a nanogap electrode device, the method comprising,
providing a first electrode and a second electrode spaced apart from each other, said first and second electrodes defining a first region and a second region,
forming a first gap between the first electrode and the second electrode in the first region, said first gap having a first gap length and a first gap width;
forming a second gap between the first electrode and the second electrode in the second region, said second gap having a second gap length and a second gap width;
wherein the second gap length and second gap width are greater than the first gap width.

12. The method according to claim 11, wherein the second gap width is greater than the first gap width by a factor of from 3.75 to 60.

13. The method according to claim 11, wherein the first gap width falls in a range of from 50 nm to 400 nm, and the second gap width falls in a range of from 1500 nm to 3000 nm; and optionally
wherein the first gap length falls within a range of from 600 nm to 1000 nm, and the second gap length falls within a range of from 500 nm to 900 nm.

14. (canceled)

15. The method according to claim 11, further comprising providing a plurality of alternating first and second regions defined by the first and second electrodes.

16. The method according to claim 11, wherein providing the first and second electrodes comprises forming a sensing region having an area defined by the first gap length and the first gap width.

17. The method according to claim 11, wherein providing the first and second electrodes comprises forming a reservoir region having an area defined by the second gap length and the second gap width.

18. The method according to claim 11, further comprising
providing a surface modification layer substantially uniformly disposed on the first and second electrodes; and
providing a layer of biomolecules substantially uniformly disposed on the surface modification layer.

19. The method according to claim 11, wherein providing the first and second electrodes comprises providing a continuous length of material for each of the first and second electrodes, said continuous length of material arranged to form a plurality of horizontal members and a plurality of lateral members;
wherein each one of the plurality of horizontal members of the first electrode has a corresponding horizontal member of the second electrode which is substantially parallel to each other, and each horizontal member comprises a first end and a second end; and
wherein the plurality of lateral members is orthogonally arranged with respect to the plurality of horizontal members, and each lateral member either connects the first ends of two adjacent horizontal members or the second ends of two adjacent horizontal members.

20. The method according to claim 19, wherein the horizontal member has a length falling in a range of from 400 nm to 1200 nm, and the lateral member has a length falling in a range of from 600 nm to 1400 nm.

21. A sensor for detecting a target analyte, said sensor comprising, a nanogap electrode device comprising,
a first electrode and a second electrode spaced apart from each other, said first and second electrodes defining a first region and a second region;
wherein the first region comprises a first gap between the first electrode and the second electrode, said first gap having a first gap length and a first gap width;
wherein the second region comprises a second gap between the first electrode and the second electrode, said second gap having a second gap length and a second gap width; and
wherein the second gap length and second gap width are greater than the first gap width.
